(19) United States
(12) Patent Application Publication
(10) Pub. No.: US 2014/0012754 A1
(43) Pub. Date: Jan. 9, 2014

(54) FINANCIAL DOCUMENT PROCESSING SYSTEM

(71) Applicants: Carrie Anne HANSON, Charlotte, NC (US); Scott R. ENSCOE, Charlotte, NC (US); Alexander C. WITTKOWSKI, Charlotte, NC (US); David M. GRIGG, Rock Hill, SC (US); Daniel DAVID, Charlotte, NC (US); Katherine DINTENFASS, Charlotte, NC (US); Ray R. HERNANDEZ, Austin, TX (US); Brett NEWMAN, Burlingame, CA (US); Leo KOPELOW, San Francisco, CA (US); Yameng LI, Berkeley, CA (US); Nicole CHEN, San Francisco, CA (US); Nicholas SHARP, San Francisco, CA (US)

(72) Inventors: Carrie Anne HANSON, Charlotte, NC (US); Scott R. ENSCOE, Charlotte, NC (US); Alexander C. WITTKOWSKI, Charlotte, NC (US); David M. GRIGG, Rock Hill, SC (US); Daniel DAVID, Charlotte, NC (US); Katherine DINTENFASS, Charlotte, NC (US); Ray R. HERNANDEZ, Austin, TX (US); Brett NEWMAN, Burlingame, CA (US); Leo KOPELOW, San Francisco, CA (US); Yameng LI, Berkeley, CA (US); Nicole CHEN, San Francisco, CA (US); Nicholas SHARP, San Francisco, CA (US)

(73) Assignee: BANK OF AMERICA CORPORATION, Charlotte, NC (US)

(21) Appl. No.: 13/543,676

(22) Filed: Jul. 6, 2012

(51) Int. Cl. G06Q 20/40

(52) U.S. Cl. 705/44

(57) ABSTRACT

Embodiments of the invention relate to systems, methods, and computer program products for providing a financial document processing system. The system receives an image of a financial document, such as a check, and identifies at least a transaction amount from the financial document. Then the system determines account information associated with the financial document. The system may identify a routing and account number on the financial document or identify the document based on a name on the document. Once the transaction amount and account information are known, the system determines a prospective balance for a financial account based on the account information and the transaction amount. If there are funds at least equal to the transaction amount in the financial account, the system validates the transactions. In some embodiments, the system also immediately updates the balance of the account and/or offers to complete the transaction.

### BACKGROUND

People use financial documents such as checks to conduct transactions with other people or with businesses. There is a delay, however, between when a financial document is executed or exchanged between parties and when the funds associated with the financial document are drawn from or deposited into the account. In this situation, the posted balance for the account may not reflect the pending transaction based on the financial document. Thus, people may have difficulty budgeting because of the discrepancy in the posted balance and the actual balance taking into account the financial document.

Thus, there is a need for a system that processes financial documents immediately, allows confirmation of available balances, and assists in transferring funds.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments provide a financial document processing system, wherein the system includes a memory device, a communication device, and a processing device. The processing device is operatively coupled to the memory device and the communication device and configured to execute computer-readable program code to receive an image of a financial document, wherein the image of the financial document includes a transaction amount. The system determines, via a computing device processor, account information associated with the financial document; determines, via a computing device processor, a prospective balance for a financial account based on the account information and the transaction amount; and validate the financial document based on the prospective balance. In some embodiments, validating the financial document includes informing a user that funds at least equal to the transaction amount are available in the financial account. In still further embodiments, the system also includes immediately updating a balance of the financial account based on the transaction amount. For example, the system may cause the balance to be displayed based on the transaction amount but does not transfer funds until the financial document is processed by standard means.

In some embodiments, the system also offers to complete the transaction wirelessly. For example, the system may receive instructions from a user; determine an identity of the user; and complete the transaction when the user is authorized to perform the transaction. The system may use an electronic check, a person-to-person or person-to-merchant transfer, or other type of wireless transfer. In further embodiments, the system may determine a trend in the financial account based on a transaction history of the financial account; and validate the transaction when the trend indicates sufficient funds will remain in the account based on the trend and the transaction amount. In still further embodiments, the system further includes identifying the financial document based on the location of at least two elements in the image relative to one another, wherein the location of the two elements corresponds to a known location of elements in a financial document.

In an embodiment, a financial document processing computer program product is provided. The computer program product includes at least one non-transitory computer-readable medium having computer-readable program code portions embodied therein. In some embodiments, the computer-readable program code portions include an executable portion configured for receiving an image of a financial document, wherein the image of the financial document includes a transaction amount. The computer-readable program code portions may also include an executable portion configured for determining account information associated with the financial document; and an executable portion configured for determining a prospective balance for a financial account based on the account information and the transaction amount. Finally, the computer-readable program code portions may include an executable portion configured for validating the financial document based on the prospective balance.

In some embodiments, validating the financial document includes informing a user that funds at least equal to the transaction amount are available in the financial account. In some embodiments, the system also includes immediately updating a balance of the financial account based on the transaction amount. For example, updating displays the balance based on the transaction amount but does not transfer funds until the financial document is processed by standard means. The computer program product may also include an executable portion configured to offer to complete the transaction wirelessly. The computer program product may receive instructions from a user and determine an identity of the user. When the user is authorized to perform the transaction, the computer program product completes the transaction. The computer program product may also include an executable portion configured to: determine a trend in the financial account based on a transaction history of the financial account; and validate the transaction when the trend indicates sufficient funds will remain in the account based on the trend and the transaction amount.

In an embodiment, a financial document processing method is provided. The method uses a computer processor of the financial document processing method computer program code instructions stored in a non-transitory computer readable medium, wherein said computer program code instructions are structured to cause said computer processor to receive an image of a financial document, wherein the image of the financial document comprises a transaction amount. The method also determines, via a computing device processor, account information associated with the financial document; and determines, via a computing device processor, a prospective balance for a financial account based on the account information and the transaction amount. The method then validates the financial document based on the prospective balance. In some embodiments, validating the financial document comprises informing a user that funds at least equal to the transaction amount are available in the financial account. The method may also immediately update a balance of the financial account based on the transaction amount. For example, the updating may display the balance based on the transaction amount but does not transfer funds until the financial document is processed by standard means.

In some embodiments, the method includes offering to complete the transaction wirelessly. The method may receive instructions from a user; and determining an identity of the user. When the user is authorized to perform the transaction, the method completes the transaction. In still further embodiments, the method includes determining a trend in the financial account based on a transaction history of the financial account; and validating the transaction when the trend indicates sufficient funds will remain in the account based on the trend and the transaction amount. Finally, the method may also include identifying the financial document based on the location of at least two elements in the image relative to one another, wherein the location of the two elements corresponds to a known location of elements in a financial document.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for providing a financial document processing system, in accordance with some embodiments of the invention;

FIG. 2 is a depiction of an environment in which an apparatus provides a financial document processing system, in accordance with some embodiments of the invention;

FIG. 3 is a block diagram illustrating a mobile device, in accordance with an embodiment of the invention;

FIG. 4 is a block diagram of a financial document processing system, in accordance with some embodiments of the invention;

FIGS. 5A and 5B are flow charts of a system for providing a financial document processing system, in accordance with some embodiments of the invention; and

FIG. 6 is an example of a financial document being processed by a financial document processing system, in accordance with some embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Additionally, while embodiments are disclosed as “comprising” elements, it should be understood that the embodiments may also “consist of” elements or “consist essentially of” elements.

Although embodiments of the present invention described herein are generally described as involving a merchant, it will be understood that merchant may involve one or more persons, organizations, businesses, institutions and/or other entities such as financial institutions, services providers, stores, entities, and such that implement one or more portions of one or more of the embodiments described and/or contemplated herein.

Apparatuses, systems, methods and computer program products are herein disclosed for providing a financial document processing system. Specific embodiments disclosed herein relate to a financial document processing system for processing financial documents using a mobile device. The system captures an image of a financial document, evaluates an account of the user, and in some embodiments deducts a transaction amount based on the financial document from the account of the user. In some embodiments, the system confirms available funds or instantly transfers the funds to a recipient. While the financial documents are primarily described as paper checks from a checking account, it should be understood that other types of financial documents may be included in the invention as described herein. For example, bonds, IOU's, rebates, and/or refunds may also be processed by the system.

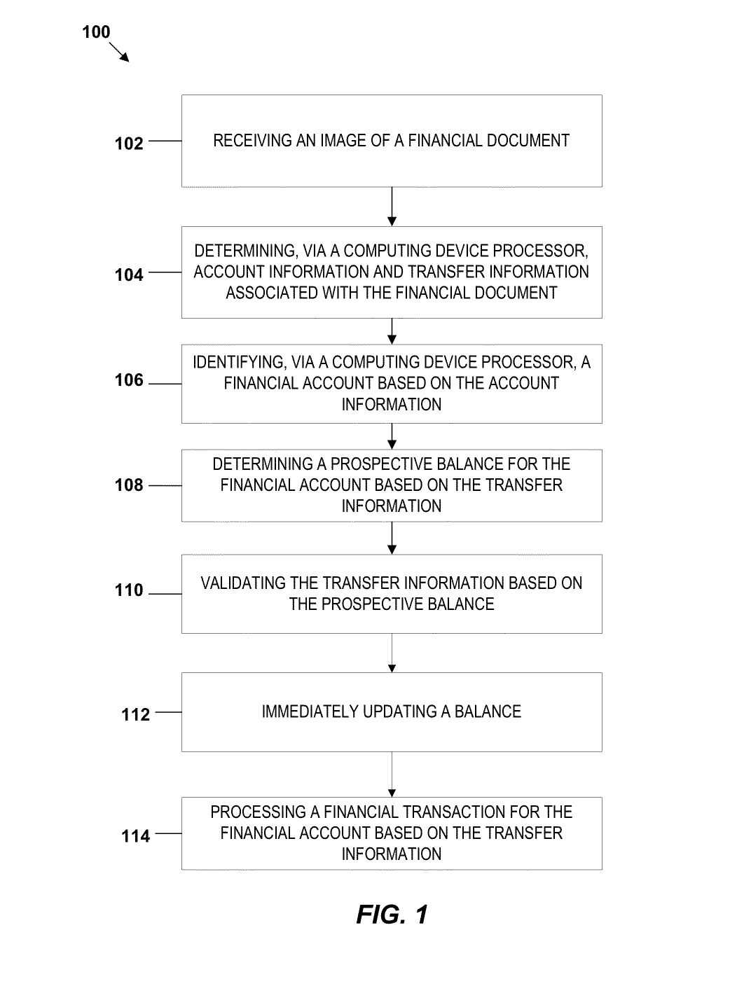

FIG. 1 illustrates a general process flow 100 for an apparatus or system for providing a financial document processing system consistent with an embodiment of the present invention. As shown in block 102, the system receives an image of a financial document. In an embodiment, the system receives the image of the financial document through a camera associated with the system. For example, a camera on a mobile device may provide the image to the system. The image may be provided as a still shot, e.g., photograph, or a video. In some embodiments, still shots are extracted from videos provided to the system. In a further embodiment, the image is provided to the system through a communications device, such as via email or text message.

In block 104, the system determines, via a computing device processor, account information and transfer information associated with the financial account. In some embodiments, account information and transfer information are determined using image analysis software. For example, software capable of identifying text and/or numbers may extract the account number, routing number, recipient name, and/or amount from the financial document. In another embodiment, the financial document includes a device or code indicating the account number and/or routing number. For example, a bar code or other scannable code may be printed on or embedded in the financial document. The bar code may be a two-dimensional or a three-dimensional. For example, the bar code may be a QR code, matrix bar codes, color bar codes, and the like.

As discussed, the account information may include the routing number, which in some embodiments identifies a financial institution hosting an account associated with the financial document. The account information may also include an account number that identifies the relevant account in the financial institution. In some embodiments, additional account information is also determined. For example, an owner of the account, an address associated with the account, and/or a transaction history associated with the account may be identified through the routing number and account number or based on information printed on or embedded in the financial document. For example, in many cases the name and address of the account owner is printed on the face of the financial document.

In some embodiments, the transfer information includes the amount of the transaction based on the financial document. In some embodiments, the system extracts the amount from two locations on the financial document and compares the amounts to confirm the amount of the transaction. For example, in many checks the amount is both written out in letters and also included as a number amount. Comparing these two amounts can reduce the likelihood that incorrect amounts are identified in the financial document.

In further embodiments, the transfer information includes the recipient of the funds associated with the financial document. For example, a recipient name (e.g., a person or business) may be written on a check and identified by the system. Still further, the date of the transfer and/or the location of the transfer may be identified. In an embodiment, the recipient name and the current location of the user is identified so that the recipient account may be identified. For example, the recipient name may be identified based on writing on the financial document and the location may be identified using the positioning system device associated with the mobile device. The recipient may have a default account that is used for receiving payments associated with electronic checks or wireless transfers. In some embodiments, the recipient's account number is written or available on the financial document, such as a detailed financial transfer form. In a still further embodiment, the recipient account is available over a wireless network in the recipient business. For example, the business may transmit the account number for receiving wireless payments over a network. In a still further embodiment, the system may prompt the user to identify an account for the recipient. For example, the system may identify previous transactions between the user and the recipient based on the user's transaction history, and then identify the accounts that have received the funds for the recipient. These accounts are offered to the user as potential recipient accounts and the user is given an opportunity to select an account for transferring the funds.

In block 106, in some embodiments the system identifies, via a computing device processor, a financial account based on the account information. The financial account may be identified based on communications with a financial institution database. For example, the system may identify the routing number and account number from the financial document and then query the financial institution database for the financial account associated with the account number. In some embodiments, additional information is identified, such as the current balance of the account, any pending transactions associated with the account, and/or a trend in the balance of the account based on the account's transaction history. For example, the account's transaction history may be identified and a trend wherein the user deposits a paycheck on the 1^{st} and 15^{th} of every month and pays a mortgage on the 5^{th} of every month is determined. In this manner, the system not only identifies the current balance in the account but also identifies major or recurring expenses and deposits associated with the account.

As shown in block 108, in some embodiments, the system determines a prospective balance for the financial account based on the transfer information. The system may use the transaction amount identified from the financial document to determine a prospective balance for the financial account if the financial transaction were to proceed. In the embodiment where the financial document is a check, the system may identify the amount indicated in the check and subtract the amount from the current balance of the financial account to identify a prospective balance. In further embodiments, the balance of the financial account is based on the current balance and pending transactions. In a still further embodiment, the prospective balance is based on the transaction amount, the balance of the account, and the trend associated with the account. For example, the system may determine that the account has sufficient funds to cover the financial transaction but that historically the account has a large withdrawal that would send the account to negative if the transaction were to occur.

Turning now to block 110, in some embodiments the system validates the transfer information based on the prospective balance. In some embodiments, the system confirms that funds at least equal to the transaction amount are available in the financial account. In further embodiments, the system provides the prospective balance to a user. In one embodiment, the user is the source of the funds. For example, the user may be a person writing a check to pay for an item at a store. The system may provide the prospective balance to the user through written or audible means. The prospective balance may be displayed on a screen such as screen associated with a mobile device. In some embodiments, the user receives an email or text message providing the prospective balance.

In some embodiments, the system determines that the transaction amount is greater than the amount of funds available in the account. The amount of funds available in the account may be based on the current balance, the balance considering other pending transactions, and/or the balance considering trends in the financial account. In this embodiment, the system may offer to transfer funds from a linked account, may offer to open another account (e.g., a credit account) to provide additional funds, or may offer to allow the transaction to proceed for a payment.

In a further embodiment, the user is the recipient of the funds. For example, the user may be the business that is receiving the check to pay for the item. In an embodiment, the business uses a device to scan a check and confirm that the check will clear. In this scenario, the fund provider may set privacy settings that determine how the prospective balance is determined. For example, the fund provider (e.g., the person writing the check) may indicate that prospective balances determined by fund recipients are only calculated based on the current balance and pending transactions. Trends in the fund provider's account may not be analyzed when the user is a fund recipient because the fund provider may plan on transferring funds into the account prior to future expenses. In this way, the system may validate a transaction and confirm to both parties that sufficient funds are available for the financial document.

In block 112, the system immediately updates the balance of the account to take into account the transaction amount. In this way, the user has a more accurate value for the account balance than if the balance is updated only after the financial document is processed through standard means. In another embodiment, the system may prompt the user for permission before updating the balance based on the amount information. In some embodiments, the funds are still available in the account until the financial document is processed but the funds do not show up as available to assist the user in budgeting. In still further embodiments, the funds are still available in the account until the financial document is processed but the funds are flagged for the financial document so that future transactions are rejected if they would lower the balance of the account below the amount of the financial document.

In some embodiments, a pseudo-balance is determined for the account considering pending transactions based on financial documents processed using the financial document processing system. For example, the user may scan a check to determine whether sufficient funds are available in the payee account to cover the amount of the check. The system may validate the transfer information based on sufficient funds being available in the account. The system may then also populate a pseudo-balance based on the balance of the account and the amount of the financial document. This pseudo-balance can then be used in various financial planning programs associated with the user. For example, the pseudo-balance can be used with a bill pay system. If the bill pay system determines that funds will not be available to cover upcoming bills processed through the bill pay system based on the pseudo-balance, even if funds are currently in the account because the financial document has not yet been reconciled through standard channels, the bill pay system can alert the user to the potential issue and recommend transferring funds into the account. Similarly, budgeting programs that evaluate an individual's, business's or family's progress on a budget can use the pseudo-balance to provide an accurate picture of the budget progress based on transactions that have been initiated and processed using the financial document processing system but not reconciled through standard practices. Other types of financial systems that may use the pseudo-balance include rewards systems (e.g., points based on spend), foreign currency exchanges (e.g., exchange rate at time of initiation of transaction rather than at time of processing), investment activities, calendar programs, and the like.

In further embodiments (not shown), the system confirms with the user that the financial document has been deposited and processed through standard practices. For example, the financial document processing system may post the pseudo-balance but also alert the user when a check is deposited and the funds clear through the standard check processing systems. The alert may be via email, text message, secure online message, or the like. In an embodiment, the system includes a time period during which the system tracks whether the financial document has been processed through standard means. If the financial document is not processed through standard means during the time period, which may be a default time period or a user-defined time period, the financial system, user, and/or recipient of the financial document may be alerted. For example, a user may user a check to pay for services. The user may use the financial document processing system to validate the check and create a pseudo-balance taking into account the amount of the check. The user may also set a time period of six months to watch for the check being reconciled through standard check processing means. If the check is not processed through standard means during the six months, the user may receive a notice at the end of the six months. Optionally, the financial institution or the recipient of the check may also receive a notice. In this way, financial documents are less likely to be misplaced or delayed in processing. In some embodiments, the system also reconciles any differences between the transaction information processed through the financial document processing system (e.g., amount) and the transaction information processed when processing the financial document through standard means. For example, if the amount differs then the financial institution may flag the transaction for review and correction, if necessary.

Finally, in some embodiments depicted in block 114, the system processes a financial transaction for the financial account based on the financial document. While in some embodiments, the system concludes the process by validating the transaction, i.e., indicating that sufficient funds are available based on the prospective balance, and/or updating the balance based on the financial document, in further embodiments the system offers to facilitate the transaction associated with the financial document. For example, the system may offer to transfer the funds immediately from the payor account to the recipient account. The transaction may be processed wirelessly based on the account information and transfer information associated with the financial document. In an embodiment, the system instructs the financial institution accounting system to transfer funds. In some embodiments, the user authorizes the transaction based on an identity of the mobile device, a code entered by the user into the mobile device, a signature signed on a touch-sensitive screen of the mobile device, or a biometric scan by the mobile device (e.g., fingerprint).

In an embodiment, the system also begins reconciling the financial document through standard means. The recipient of the funds in the financial document may be informed that the financial document will soon be processed. In some embodiments, a pseudo-account is created for the recipient of the funds as well taking into account the pending transaction based on the financial document. Identifying information in the financial document may also be provided to the recipient of the funds, such as an invoice number printed on the financial document, the payee name, the date, and the like. In this manner, both the payee and the recipient (e.g., the merchant) benefit. The payee has a more accurate depiction of funds available in the account based on transaction that have been initiated but not yet processed and the recipient gets notice of pending transactions to facilitate reconciling the transactions and record keeping.

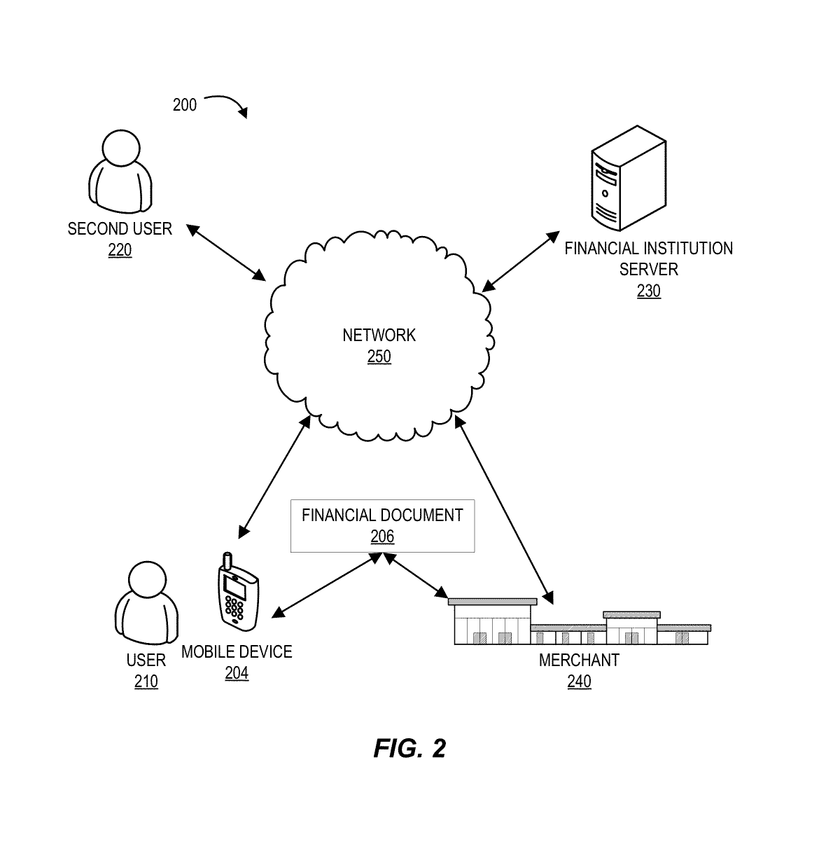

Referring to FIG. 2, a block diagram illustrating an environment 200 in which a financial document processing system processes financial documents 206 using a mobile device 204 is provided. The system captures an image of the financial document 206 using the mobile device 204, extracts account information from the financial document 206, and evaluates an account associated with the account information on the financial institution server 230. In some embodiments, recipients of the financial document, such as a second user 220 or a merchant 240, use the system to confirm available funds for the financial document. In a still further embodiment, the system offers to transfer the funds from the user's financial account to the recipient's financial account at the financial institution server 230.

As shown in FIG. 2, the mobile device and the financial document processing system communicate with one another and in some embodiments with secondary users 220 and merchants 240 over a network 250, which may include one or more separate networks. In addition, the network 250 may include a local area network (LAN), a wide area network (WAN), and/or a global area network (GAN), such as the Internet. It will also be understood that the network 250 may be secure and/or unsecure and may also include wireless and/or wireline technology.

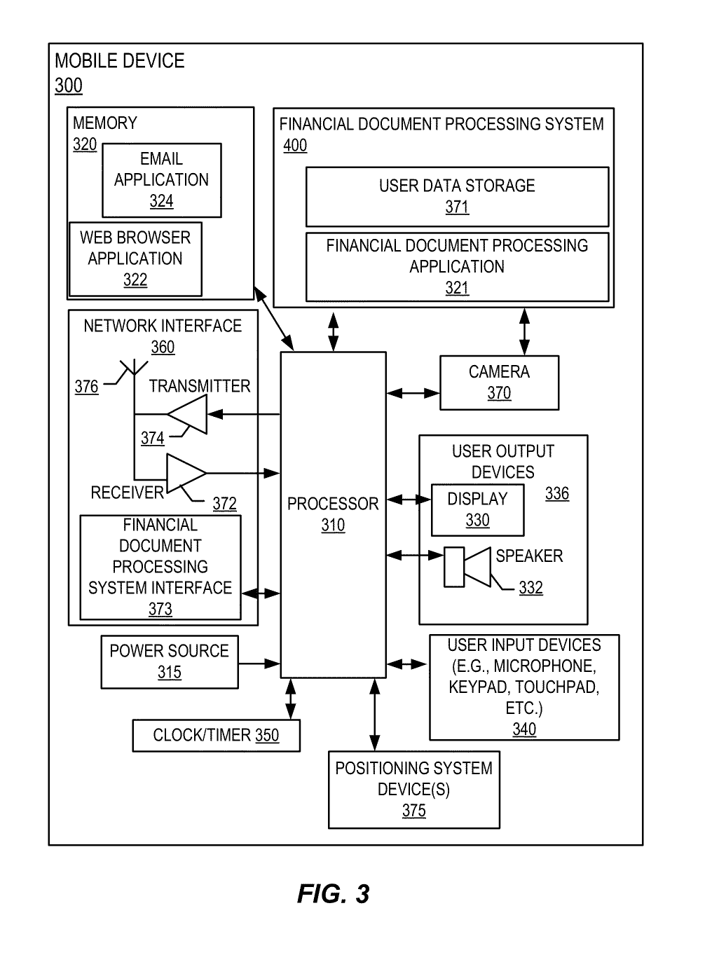

FIG. 3 illustrates an embodiment of a mobile device 300 that may be configured with the financial document processing system. A “mobile device” 300 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like.

The mobile device 300 may generally include a processor 310 communicably coupled to such components as a memory 320, user output devices 336, user input devices 340, a network interface 360, a power source 315, a clock or other timer 350, a camera 370, at least one positioning system device 375, one or more financial document processing systems 400, and the like. The processor 310, and other processors described herein, may generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

In some embodiments, the positioning system device 375 is configured to determine the location of the mobile device. For example, at least one of the positioning system devices 375 may interact with the transceiver to send and/or receive information with wireless transmitters, such as GPS or Wi-Fi. In further embodiments, the positioning system device 375 is configured to determine movement and/or orientation of the mobile device. Accelerometers, magnetometers, and other devices can be included in the mobile device to provide information to the device on the location and velocity (speed and direction) of the device. Other types of positioning system devices 375 may be included in the device without limitation. For example, altimeters can be included in the device to determine the elevation of the device. Similarly, electronic or standard compasses may be included.

The processor 310 may also be capable of operating applications, such as a financial document processing application 321. The financial document processing application 321 may be downloaded from a server and stored in the memory 320 of the mobile device 300. Alternatively, the financial document processing application 321 may be pre-installed and stored in a memory of the financial document processing system 400 or activated directly from a website operably linked to the mobile device 300 through the network interface 360. In embodiments where the financial document processing application 321 is pre-installed or run from a website, the user may not download the financial document processing application 321 from a server.

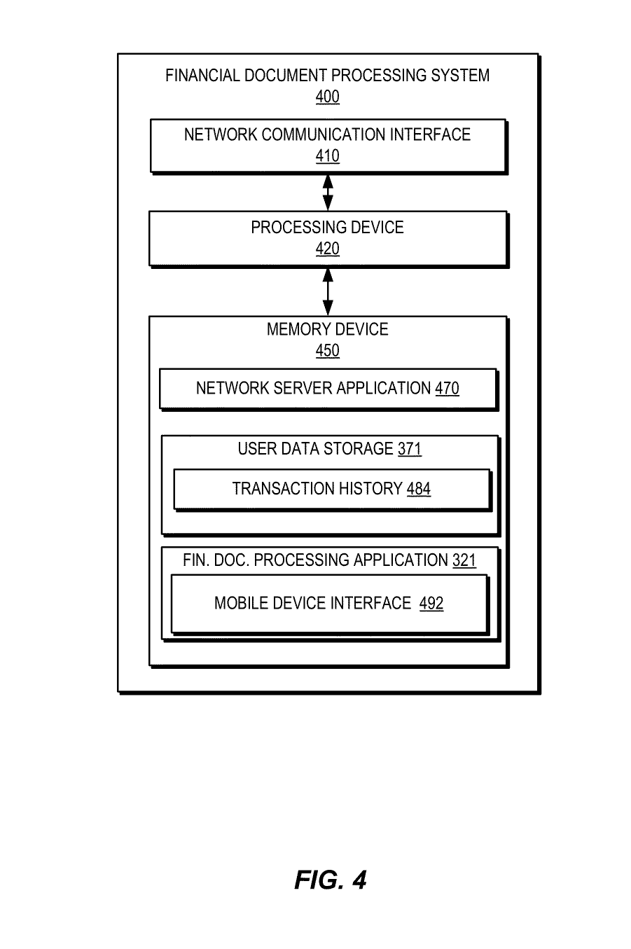

The financial document processing system 400, as will be discussed in greater detail in FIG. 4, may include the necessary circuitry to provide the financial document processing functionality to the mobile device 300. Generally, the financial document processing system 400 will include user data storage 371, i.e., a database, which may include data associated with the financial accounts. The financial document processing system 400 and/or user data storage 371 may be an integrated circuit, a microprocessor, a system-on-a-chip, a microcontroller, or the like. As discussed above, in one embodiment, the financial document processing system 400 provides the financial document processing functionality to the mobile device 300.

Of note, while FIG. 3 illustrates the financial document processing system 400 as a separate and distinct element associated with the mobile device 300, it will be apparent to those skilled in the art that the financial document processing system 400 functionality may be incorporated within other elements in the mobile device 300. For instance, the functionality of the financial document processing system 400 may be incorporated within the mobile device memory 320 and/or the processor 310. In a particular embodiment, the functionality of the financial document processing system 400 is incorporated in an element within the mobile device 300 that provides financial document processing capabilities to the mobile device 300. Moreover, the functionality may be part of the firmware of the mobile device 300. In some embodiments, the functionality is part of an application downloaded and installed on the mobile device 300. Still further, the financial document processing system 400 functionality may be included in a removable storage device such as an SD card or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include a financial document processing interface 373 in order to allow a user to execute some or all of the above-described processes with respect to the financial document processing application 321 and/or the financial document processing system 400. The financial document processing interface 373 may have access to the hardware, e.g., the transceiver, and software previously described with respect to the network interface 360. Furthermore, the financial document processing interface 373 may have the ability to connect to and communicate with an external financial document processing system 400, such as a system that attaches to or wirelessly communicates with the mobile device 300.

As described above, the mobile device 300 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. The user input devices 340, which may allow the mobile device 300 to receive data from a user 210, may include any of a number of devices allowing the mobile device 300 to receive data from a user 210, such as a keypad, keyboard, touch-screen, touchpad, microphone, mouse, joystick, stylus, other pointer device, button, soft key, and/or other input device(s).

The mobile device 300 may further include a power source 315. Generally, the power source 315 is a device that supplies electrical energy to an electrical load. In one embodiment, power source 315 may convert a form of energy such as solar energy, chemical energy, mechanical energy, and such to electrical energy. Generally, the power source 315 in the mobile device 300 may be a battery, such as a lithium battery, a nickel-metal hydride battery, or the like, that is used for powering various circuits, e.g., the transceiver circuit, and other devices that are used to operate the mobile device 300. Alternatively, the power source 315 may be a power adapter that can connect a power supply from a power outlet to the mobile device 300. In such embodiments, a power adapter may be classified as a power source “in” the mobile device.

The mobile device 300 may also include the memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs which comprise computer-executable instructions/code executed by the processor 310 to implement the functions of the mobile device 300 described herein. For example, the memory 320 may include such applications as a financial document processing application 321, a web browser application 322, an SMS application, an email application 324, and the like.

FIG. 4 provides a block diagram illustrating the financial document processing system 400 in greater detail, in accordance with embodiments of the invention. As illustrated in FIG. 4, in one embodiment of the invention, the financial document processing system 400 includes a processing device 420 operatively coupled to a network communication interface 410 and a memory device 450.

It should be understood that the memory device 450 may include one or more databases or other data structures/repositories. The memory device 450 also includes computer-executable program code that instructs the processing device 420 to operate the network communication interface 410 to perform certain communication functions of the financial document processing system 400 described herein. For example, in one embodiment of the financial document processing system 400, the memory device 450 includes, but is not limited to, a network server application 470, a user data storage 371, which includes transaction history 484, a financial document processing application 321, which includes a mobile device interface 492, and other computer-executable instructions or other data. The computer-executable program code of the network server application 470 or the financial document processing application 321 may instruct the processing device 420 to perform certain logic, data-processing, and data-storing functions of the financial document processing system 400 described herein, as well as communication functions of the financial document processing system 400, such as communication with a mobile device and/or a wireless server.

In some embodiments, the financial document processing application 321 is the same application as located on the mobile device. In other embodiments, some functionality is present in the financial document processing system 400 and some functionality is present in the mobile device. As should be understood, the software and hardware providing the financial document processing functionality can be entirely present on the mobile device, entirely present on the financial document processing system 400, or divided in some manner between the mobile device and the financial document processing system 400. In further embodiments, the financial document processing system 400 also contributes to the financial document processing functionality by augmenting data and/or processing power of the financial document processing application(s) 321.

In further embodiments, the mobile device interface 492 facilitates communication between the mobile device and the financial document processing system 400. For example, the mobile device interface 492 may establish a connection with the mobile device, may encrypt or decrypt communications with the mobile device, or may provide a portal for the user to interact with the financial document processing application 321 through the mobile device.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network 250, such as the mobile device 300, the financial document processing system 400, and remote servers. The processing device 420 is configured to use the network communication interface 410 to transmit and/or receive data and/or commands to and/or from the other devices connected to the network 250.

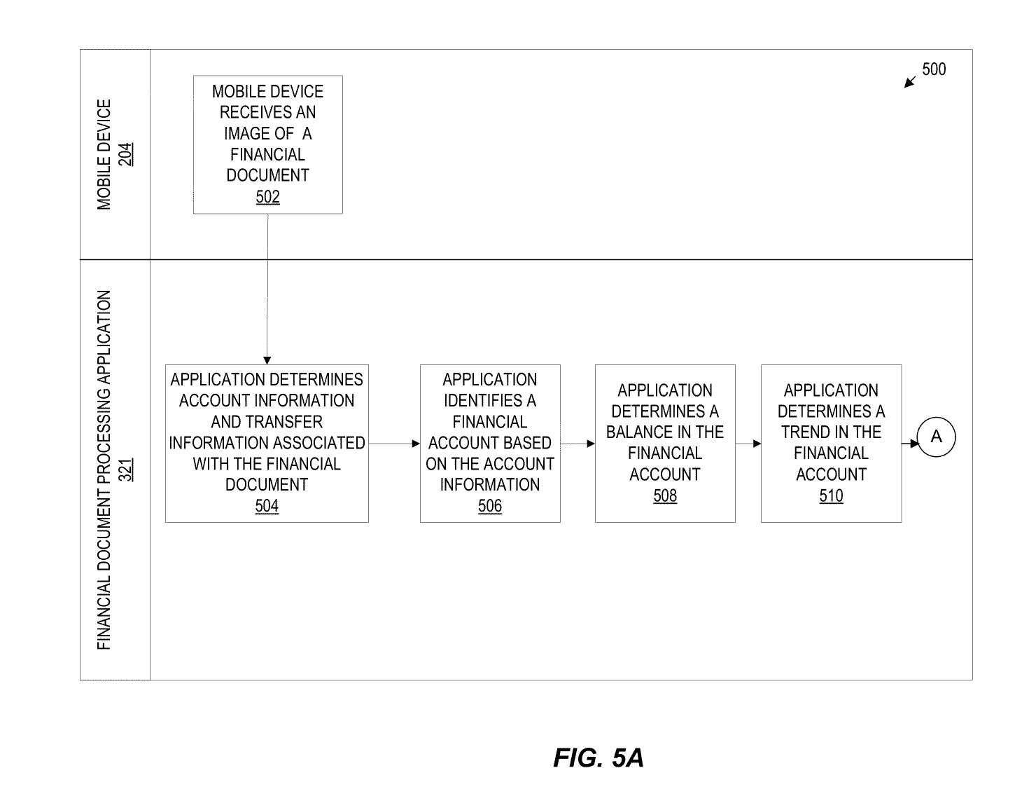

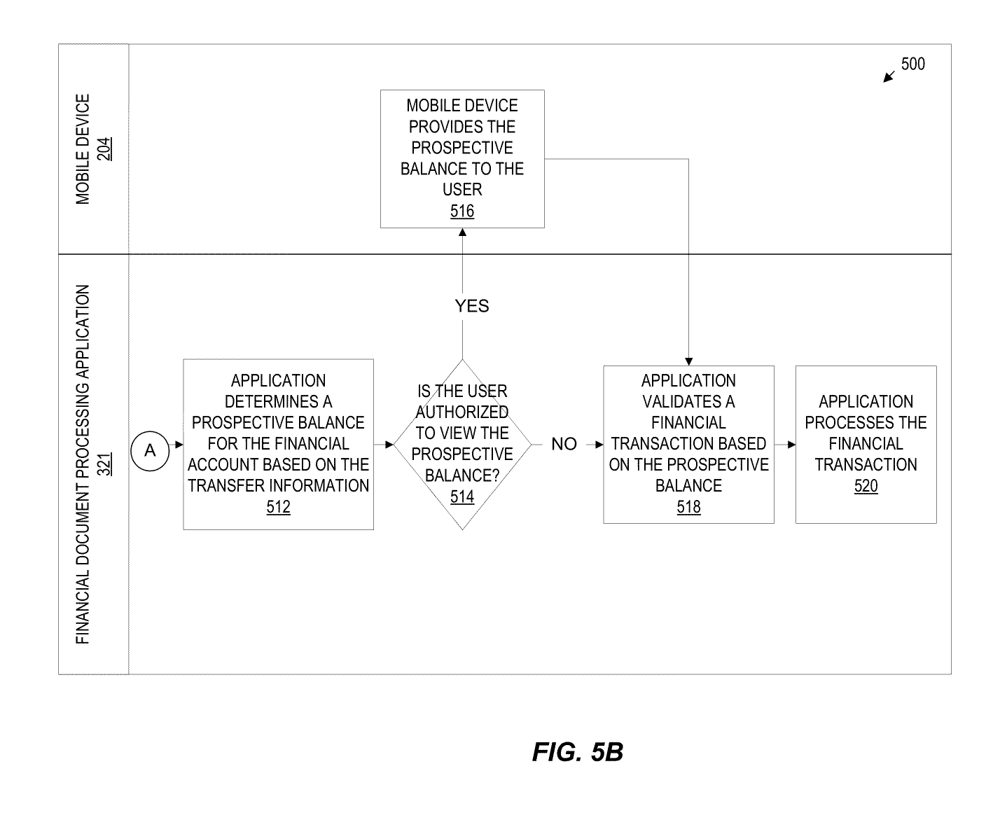

FIG. 5 is a process flow 500 illustrating a process flow for implementing a financial document processing system, in accordance with embodiments of the invention. FIG. 5 depicts some of the process by which a mobile device receives an image of a financial document, identifies information associated with the financial document, and validates a financial transaction based on the information. In some embodiments, the process automatically deducts the funds associated from the financial document from the available balance in the account associated with the financial document. In further embodiments, the process provides a prospective balance to a user so that the user can decide whether to complete the transaction using the financial document. In still further embodiments, the process completes the financial transaction for the user so that the user does not need to use the financial document. It should be understood that the steps and actions described herein are examples and that one skilled in the art could envision other possibilities for use of the financial document processing system as described herein.

Turning now to block 502, in some embodiments a mobile device receives an image of a financial document. As discussed throughout, in many embodiments the system is implemented through a mobile device, such as an application on a mobile device or an integral part of the programming of a mobile device. The system may utilize the mobile device's input devices, such as a still camera or video camera, to receive an image of a financial document. In some embodiments, the financial document is scanned by the video camera of the mobile device and the image of the financial document is captured from the video stream. For example, in some embodiments, a standard structure of a financial document, e.g., a check, is stored in a memory device associated with the mobile device. The system is configured to match an object or objects identified in the video stream with the standard structure of the financial document to identify financial documents in the video stream. For example, elements of a financial document such as routing numbers, account numbers, and amounts are often in a standardized location on paper checks. The system may scan an image for these elements in the correct relationship relative to one another in the image and identify the financial document in that manner.

In another embodiment, the mobile device receives the image of the financial document from a communication means. For example, the image of the financial document may be emailed or sent via text message to the system or to a mobile device associated with the system. In an embodiment, the system has a dedicated address for receiving financial documents, such as an email address used solely for receiving financial documents, while in another embodiment the system receives images of financial documents at general-use addresses.

In block 504, in some embodiments the application determines account information and transfer information associated with the financial document. In an embodiment, the account information comprises an account number. The account information may also comprise a routing number or host of the financial account, a name on the account, a mailing address for the account, and/or a financial transaction history of the account. In some embodiments, the system determines the account information based on image analysis, such as text recognition software, that evaluates text in the image and determines the account information from the text. In another embodiment, the system identifies a code on the financial document that provides the account information. For example, a bar code may replace a routing number in order to identify the institution where the account is held. In a still further embodiment, a sensor is built into the financial document, such as a sensor or emitter, which contains the account information.

In an embodiment, the transfer information comprises an amount for a financial transaction being executed by the financial document. In some embodiments, the transfer information also includes the recipient of the funds and/or the date that the financial document was signed. In some embodiments, the transfer information comprises a subject line comment as well. An invoice number may be printed on the financial document and associated with the transaction using the financial document processing system. The recipient of the funds may be identified by name, account number, address, or other identifying means (e.g., alias). In some embodiments, the recipient of the funds is identified in coordination with the location of the user. For example, the positioning system device can be used to identify the user's current location and the recipient of the funds can be identified based on the location. For example, the user's current location may be in or proximate to a merchant known to be established at a location and therefore the system determines that the recipient is the merchant. In some embodiments, the user is prompted to confirm the identity of the recipient, such as confirming by selecting an option on a mobile device. For example, the system may identify previous transactions between the user and the recipient based on the user's transaction history, and then identify the accounts that have received the funds for the recipient. These accounts are offered to the user as potential recipient accounts and the user is given an opportunity to select an account for transferring the funds.

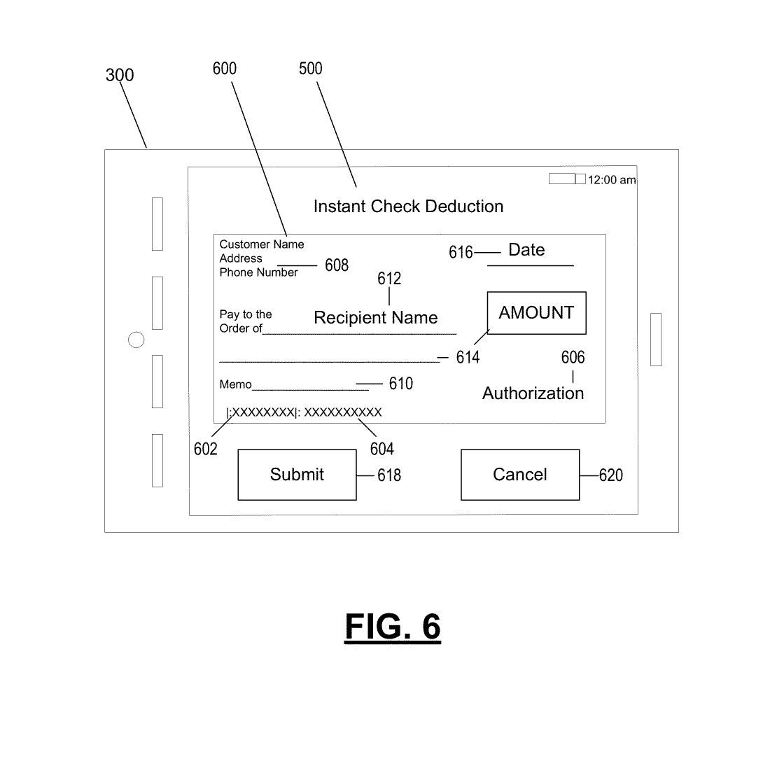

Turning briefly to FIG. 6, an example of a financial document 600 captured by a mobile device 300 in a financial document processing system 500 is provided. The financial document 600 includes account information, such as a routing number 602 and an account number 604. The financial document 600 may also include information such as authorization 606, the customer name and address 608, or a memo line 610. In this example, the financial document 600 also includes the recipient name 612, the amount 614 (included as both numbers and written out using words), and the date 616 of the financial document. The financial document processing system 500 identifies this information and allows the user to submit 618 or cancel 620 the financial document to the system so that the user's account can display the balance based on the financial document without having to wait for the financial document to be processed through the normal means.

Returning to FIG. 5A, in block 506, the application identifies a financial account based on the account information. In one embodiment, the financial account is identified based on information stored in a financial institution database. For example, the system may identify the routing number and account number from the financial document and then query the financial institution database for the financial account associated with the account number. In some embodiments, additional information is identified, such as the current balance of the account, and/or any pending transactions associated with the account.

In block 508, the system determines a balance in the financial account. In some embodiments, the balance is the current balance of the financial account as posted as available for use. In further embodiments, the balance of the financial account is based on the current balance and pending transactions. In a still further embodiment, the balance is based on the balance of the account and a trend associated with the account. For example, the system may determine that the account has sufficient funds to cover the financial transaction but that historically the account has a large withdrawal that would send the account to negative if the transaction were to occur. Alternatively, the system may determine that the account does not currently have enough funds but that a trend in the transaction history indicates that a large deposit, e.g., a paycheck, will be deposited in the account soon and therefore the system determines a balance in the financial account based on the projected deposit.

In block 510, in one embodiment a trend in the account is determined. For example, the account's transaction history may be identified and a trend wherein the user deposits a paycheck on the 1^{st} and 15^{th} of every month and pays a mortgage on the 5^{th} of every month is identified. In this manner, the system not only identifies the current balance in the account but also identifies major or recurring expenses, transfers, and deposits associated with the account. The recurrence may be on any timeframe, for instance weekly, monthly, yearly, and the like. In a further embodiment, associated accounts are identified. For example, a savings account that receives monthly deposits from a checking account may be identified. Linking accounts in this manner may also be used to validate a transaction if the payor has sufficient funds available in a combination of accounts that are automatically linked and/or include recurring transfers.

Turning now to block 512, the application determines a prospective balance for the financial account based on the transfer information. In one embodiment, the system uses the transaction amount identified from the financial document to determine a prospective balance for the financial account if the financial transaction were to proceed. In the embodiment where the financial document is a check, the system may identify the amount indicated in the check and subtract the amount from the current balance of the financial account to identify a prospective balance. In further embodiments, the balance of the financial account is based on the current balance and pending transactions. In a still further embodiment, the prospective balance is based on the transaction amount, the balance of the account, and the trend associated with the account. As should be understood, the financial document may be a withdrawal or a deposit from the account. Thus, the prospective balance may be larger or smaller than the current balance.

In decision block 514, in some embodiments the system determines whether the user is authorized to view the prospective balance. In one embodiment, the user is the owner of the financial account and therefore is authorized to view the prospective balance. In other cases, the user may be someone other than the owner and therefore may need permission to view the prospective balance. For example, the user may be a merchant that is receiving a paper check. If the user requires permission to view the prospective balance, then the owner of the account may provide permission either at the time the prospective balance is determined or by selecting a default setting when registering for the financial document processing system. In a further embodiment, the account holder may provide authorization by writing a code or predetermined authorization word on the financial document, such as on the memo line of a check.

In block 516, if the user is authorized to view the prospective balance, then the system instructs the mobile device to provide the prospective balance to the user. The system may provide the prospective balance to the user through written or audible means. The prospective balance may be displayed on a screen such as screen associated with a mobile device. In some embodiments, the user receives an email or text message providing the prospective balance. In other embodiments, the mobile device provides an audible amount for a prospective balance.

In block 518, the application validates the transfer information based on the prospective balance. In an embodiment, the system validates the transfer information by providing a confirmation that the funds at least equal to the transaction amount are available in the financial account. In some embodiments, the system also immediately updates the balance of the account to represent the new balance based on the financial document. For example, if the current balance in the account is $1000.00 and the financial document indicates a transfer out of that account of $100.00, then the system will validate the transaction and indicate that the account has a balance of $900.00. In this way, the user has a more accurate view of the account balance than if the balance is updated only after the financial document is processed through standard means. In another embodiment, the system may prompt the user for permission before updating the balance based on the amount information. In some embodiments, the funds are still available in the account until the financial document is processed but the funds do not show up as available to assist the user in budgeting. In still further embodiments, the funds are still shown as available in the account until the financial document is processed but the funds are restricted so that future transactions cannot lower the balance of the account below the transaction amount until the financial document is processed. In another embodiment, validating the transaction includes indicating to the user that sufficient funds are available for the financial document. For example, if a merchant is validating a check using the system, the merchant may receive confirmation that sufficient funds are available to cover the check.

In block 520, in some embodiments the application processes the financial transaction. For example, the system may offer to transfer the funds immediately from the payor account to the recipient account. The transaction may be processed wirelessly based on the account information and transfer information associated with the financial document. In an embodiment, the system instructs the financial institution to transfer the funds. For example, the recipient account identified in the transfer information (e.g., through user input, reception of a wireless account signal, default recipient accounts, and the like). In some embodiments, the user authorizes the transaction based on an identity of the mobile device, a code entered by the user into the mobile device, a signature signed on a touch-sensitive screen of the mobile device, or a biometric scan by the mobile device (e.g., fingerprint). In another embodiment, the transfer is implemented through person-to-person transfers or person-to-business transfers. In a still further embodiment, a digital check is created so that the transaction can be processed immediately but a document record is still available.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

This application incorporates by reference in their entirety each of the following applications filed concurrently herewith:

U.S. application Ser. No. ______, entitled BILL CONTROL, filed Jul. 6, 2012 to Carrie Hanson et al. (Atty. Dkt. 5163US1.014033.1650);

U.S. application Ser. No. ______, entitled ELECTRONIC PROCESSING OF PAPER INVOICES, filed Jul. 6, 2012 to Carrie Hanson et al. (Atty. Dkt. 5168US1.014033.1660);

U.S. application Ser. No. ______, entitled TRANSACTION MONITORING AND SAVINGS FEATURE, filed Jul. 6, 2012 to Carrie Hanson et al. (Atty. Dkt. 5172US1.014033.1663);

U.S. application Ser. No. ______, entitled BILL PAYMENT MANAGEMENT, filed Jul. 6, 2012 to Carrie Hanson et al. (Atty. Dkt. 5173US1.014033.1662);

U.S. application Ser. No. ______, entitled EARNING REWARDS VIA BILL PAYMENT, filed Jul. 6, 2012 to Carrie Hanson et al. (Atty. Dkt. 5174US1.014033.1649);

U.S. application Ser. No. ______, entitled FUTURE ACCOUNT VIEW, filed Jul. 6, 2012 to Carrie Hanson et al. (Atty. Dkt. 5175US1.014033.1651); and

U.S. application Ser. No. ______, entitled CALENDAR BILL PAYMENT MANAGEMENT, filed Jul. 6, 2012 to Carrie Hanson et al. (Atty. Dkt. 5190US1.014033.1652).

1. A financial document processing system, the system comprising:
a memory device;
a communication device; and
a processing device, operatively coupled to the memory device and the communication device, and configured to execute computer-readable program code to:
receive, via the communication device, an image of a financial document, wherein the image of the financial document comprises a transaction amount;
determine, via a computing device processor, account information comprising a current balance in a financial account associated with the financial document;
determine an account balance trend in the financial account based on a transaction history of the financial account, wherein the account balance trend comprises recurring expenses and recurring deposits in the financial account;
determine, via a computing device processor, a prospective balance for a financial account based on the account information, the account balance trend, and the transaction amount;
determine that the prospective balance is positive for a predetermined time period based on the account balance trend, the account balance, and the transaction amount; and
validate the transaction based on the prospective balance when the account balance trend indicates positive funds will remain in the financial account by the end of the predetermined time period based on the trend and the transaction amount.

2. (canceled)

3. The system of claim 1, further comprising immediately updating a balance of the financial account based on the transaction amount.

4. The system of claim 3, wherein the updating displays the balance based on the transaction amount but does not transfer funds until the financial document is processed by standard means.

5. The system of claim 1, wherein the computer-readable program code is further configured to:
offer to complete the transaction wirelessly;
receive instructions from a user;
determine an identity of the user; and
complete the transaction when the user is authorized to perform the transaction.

6. (canceled)

7. The system of claim 6, further comprising identifying the financial document based on the location of at least two elements in the image relative to one another, wherein the location of the two elements corresponds to a known location of elements in a financial document.

8. A financial document processing computer program product, the computer program product comprising at least one non-transitory computer-readable medium having computer-readable program code portions embodied therein, the computer-readable program code portions comprising:
an executable portion configured for receiving an image of a financial document, wherein the image of the financial document comprises a transaction amount;
an executable portion configured for determining account information comprising a current balance in a financial account associated with the financial document;
an executable portion configured for determining an account balance trend in the financial account based on a transaction history of the financial account, wherein the account balance trend comprises recurring expenses and recurring deposits in the financial account;
an executable portion configured for determining a prospective balance for a financial account based on the account information, the account balance trend, and the transaction amount;
an executable portion configured for determining that the prospective balance is positive for a predetermined time period based on the account balance trend, the account balance, and the transaction amount; and
an executable portion configured for validating the transaction based on the prospective balance when the account balance trend indicates positive funds will remain in the financial account by the end of the predetermined time period based on the trend and the transaction amount.

9. (canceled)

10. The computer program product of claim 8, further comprising immediately updating a balance of the financial account based on the transaction amount.

11. The computer program product of claim 10, wherein the updating displays the balance based on the transaction amount but does not transfer funds until the financial document is processed by standard means.

12. The computer program product of claim 8, further comprising an executable portion configured to:
offer to complete the transaction wirelessly;
receive instructions from a user;
determine an identity of the user; and
complete the transaction when the user is authorized to perform the transaction.

13. (canceled)

14. A financial document processing method, the method comprising:
receiving an image of a financial document, wherein the image of the financial document comprises a transaction amount;
determining, via a computing device processor, account information comprising a current balance in a financial account associated with the financial document;
determining an account balance trend in the financial account based on a transaction history of the financial account, wherein the account balance trend comprises recurring expenses and recurring deposits in the financial account;
determining, via a computing device processor, a prospective balance for a financial account based on the account information, the account balance trend, and the transaction amount;
determining that the prospective balance is positive for a predetermined time period based on the account balance trend, the account balance, and the transaction amount; and
validating the transaction based on the prospective balance when the account balance trend indicates positive funds will remain in the financial account by the end of the predetermined time period based on the trend and the transaction amount.

15. (canceled)

16. The method of claim 14, further comprising immediately updating a balance of the financial account based on the transaction amount.

17. The method of claim 16, wherein the updating displays the balance based on the transaction amount but does not transfer funds until the financial document is processed by standard means.

18. The method of claim 14, further comprising:
offering to complete the transaction wirelessly;
receiving instructions from a user;
determining an identity of the user; and
completing the transaction when the user is authorized to perform the transaction.

19. (canceled)

20. The method of claim 14, further comprising identifying the financial document based on the location of at least two elements in the image relative to one another, wherein the location of the two elements corresponds to a known location of elements in a financial document.
